(19) United States
(12) Patent Application Publication
(10) Pub. No.: US 2011/0216776 A1
(43) Pub. Date: Sep. 8, 2011

(54) METHOD AND APPARATUS FOR ASYNCHRONOUS ORTHOGONAL FREQUENCY DIVISION MULTIPLE ACCESS

(75) Inventor: David Barr, San Jose, CA (US)

(73) Assignee: ENTROPIC COMMUNICATIONS, INC., San Diego, CA (US)

(21) Appl. No.: 13/041,662

(22) Filed: Mar. 7, 2011

Related U.S. Application Data
(60) Provisional application No. 61/310,813, filed on Mar. 5, 2010.
(60) Provisional application No. 61/320,490, filed on Apr. 2, 2010.
(60) Provisional application No. 61/328,061, filed on Apr. 26, 2010.
(60) Provisional application No. 61/371,284, filed on Aug. 6, 2010.

(51) Int. Cl. H04L 12/56

(52) U.S. Cl. 370/400

(57) ABSTRACT

A method of transmitting orthogonal frequency division multiple access signals includes transmitting a first stream of data from a first node of a network. The first stream includes a preamble and payload. A second stream of data is transmitted from a second node of the network. The second stream includes a preamble and payload, and the second stream has a shorter total length than the first stream. The transmission of the second stream starts at essentially the same time as the transmission of the first stream. A third stream of data is transmitted from the second node of the network. The third stream includes a preamble and payload. The transmission of the third stream begins at the end of the payload of the second stream and prior to the end of the transmission of the remainder of the payload of the first stream.

### CROSS-REFERENCE TO RELATED APPLICATIONS

This application claims priority under 35 U.S.C. §119(e) from Provisional Application Ser. No. 61/310,813 filed Mar. 5, 2010, the entirety of which is hereby incorporated by reference herein; Provisional Application Ser. No. 61/320,490, filed Apr. 2, 2010, the entirety of which is hereby incorporated by reference herein; Provisional Application Ser. No. 61/328,061, filed Apr. 26, 2010, the entirety of which is hereby incorporated by reference herein; and Provisional Application Ser. No. 61/371,284, filed Aug. 6, 2010, the entirety of which is hereby incorporated by reference herein.

### FIELD

This disclosure is directed generally to communication systems, and more particularly, some embodiments relate to a method and apparatus for asynchronous communication in an Orthogonal Frequency Division Multiple Access system.

### BACKGROUND

Orthogonal Frequency Division Multiple Access (OFDMA) systems are prevalent today. Typically, in an OFDMA system, the signals of several different users (i.e., entities that wish to communicate over the communication system) will each be assigned one or more unique subcarriers. Each subcarrier is generated and transmitted in a manner that allows all of the subcarriers to be transmitted concurrently without interfering with one another. Therefore, independent information streams can be modulated onto each subcarrier whereby each such subcarrier can carry independent information from a transmitter to one or more receivers.

However, in one current OFDMA system described in the Multimedia over Coax Alliance (MoCA) industry standard, MoCA 2.0 network coordinators (NCs) (sometimes referred to as network controllers) coordinate synchronous OFDMA transmissions for upstream reservation requests. That is, all participating/requesting nodes are scheduled to simultaneously transmit a preamble, followed by a payload that is transmitted simultaneously, with each node transmitting on its own set of subcarriers (i.e., subchannels).

Referring to FIG. 1, in a known OFDMA transmission technique, time-frequency slots (intervals) are granted to two transmitters T1 and T2, which may correspond to respective nodes of a network. T1 is granted a first set of logical subchannels 110a, and T2 is granted a second set of logical subchannels 110b, with T1 granted more bandwidth in this example. Time intervals are granted on the basis of fixed time duration, which may correspond to a given number of symbols (e.g., 20 symbols). Two time intervals 120a and 120b of equal duration are shown in this example.

Each packet that is sent starts at the same time so that the preambles of each packet are aligned in time. In this example, packets 132 and 142 are sent at the same time (start of time interval 120a) so that their respective preambles 133 and 143 are aligned in time. However, packets may have different lengths, e.g., due to differing lengths of respective payloads 134 and 144. Therefore, if a shorter packet (e.g., packet 132) is sent on one set of subchannels (e.g., subchannels 110a), and a longer packet (e.g., packet 142) is sent on another set of subchannels (e.g., subchannels 110b), the subchannels on which the shorter packet was sent will be padded or idle waiting for the completion of the transmission of the longer packet, as shown by idle interval 122. Additional packets may then be sent in the next time interval 120b.

In particular, in a network where all upstream traffic is destined for an NC, the beginning and end of various packet transmissions may not align precisely. This misalignment may be due by different nodes transmitting packets of various lengths (e.g., from 64˜1518 bytes each). Alternatively, this misalignment may be due to different nodes transmitting over separate subchannels with differing bit loadings and subchannel-widths. For example, a first node may be required to transmit its packets over a narrower subchannel than a second node. The first node may use a lower-order bit loading than the second node in order to improve the fidelity of the transmission. Since the system is constrained to synchronous OFDMA, a node with a short packet (destined for the NC) might have to wait for another node to finish transmitting a long packet (also destined for the NC) before the two nodes could synchronously transmit a preamble and their new payloads.

### SUMMARY

In some embodiments, a method of transmitting orthogonal frequency division multiple access signals includes transmitting, at a first transmitter of a network, a first burst of data having a first symbol length over a first time interval using a first set of one or more Orthogonal Frequency Division Multiple Access (OFDMA) subcarriers. At a second transmitter of the network, a second burst of data is transmitted having a second symbol length over a second time interval, different in duration than the first time interval. The second burst of data is transmitted using a second set of one or more OFDMA subcarriers. The first and second sets of subcarriers may be mutually exclusive.

In some embodiments, a method of transmitting orthogonal frequency division multiple access signals includes transmitting a first stream of data from a first node of a network. The first stream includes a preamble and payload. A second stream of data is transmitted from a second node of the network. The second stream includes a preamble and payload, and the second stream has a shorter total length than the first stream. The transmission of the second stream starts at essentially the same time as the transmission of the first stream. A third stream of data is transmitted from the second node of the network. The third stream includes a preamble and payload. The transmission of the third stream begins at the end of the payload of the second stream and prior to the end of the transmission of the remainder of the payload of the first stream.

In some embodiments, an apparatus (which may include a microchip) includes a processor, a computer readable storage medium, a buffer, a transmitter, a receiver, a timer, and a bus that is configured to provide communication between other apparatus components. Within each chip corresponding to a particular node, the processor functions to implement the transmission schedule for that node. Instructions stored tangibly on the storage medium may cause the processor 410 to effectuate transmission in accordance with the methods of transmitting orthogonal frequency division multiple access signals described above. Schedule orders received from a network coordinator (NC) via the receiver may be stored in the buffer. Based on the timer and the schedule received from the NC, the processor may cause the transmitter to initiate a data burst.

In some embodiments, an apparatus forms a network node on a network. The apparatus includes

In some embodiments, an apparatus forms a network node on a network. The apparatus includes a computer processor, a physical layer interface, a buffer, a timer, a bus, and a computer readable storage medium. The physical layer interface includes a transmitter and a receiver and is configured to provide communication between the apparatus and at least one other network node, including a network coordinator (NC). The buffer is coupled to the processor and is configured to store schedule orders received from the NC. The bus is configured to provide communication between the processor, the physical layer interface, the buffer, and the timer. The computer readable storage medium has computer-executable instructions stored tangibly on it. When executed, the instructions cause the processor to transmit, at a time based on the stored schedule orders and the timer, a first burst of data having a first symbol length over a first time interval using a first set of one or more orthogonal frequency division multiple access (OFDMA) subcarriers. The first burst of data has a different symbol length than a second burst of data that is transmitted at one of the other network nodes over a second time interval different in duration than the first time interval.

The bus is configured to provide communication between the processor and the physical layer interface. The computer readable storage medium has computer-executable instructions stored tangibly on it. When executed, the instructions cause the processor to transmit first and second pluralities of schedule orders to the first and second recipient network nodes, respectively. The first schedule orders instruct the first recipient node to transmit a first burst of data having a first symbol length over a first time interval using a first set of one or more orthogonal frequency division multiple access (OFDMA) subcarriers. The second schedule orders instruct the second recipient node to transmit a second burst of data having a second symbol length over a second time interval, different in duration than the first time interval, using a second set of one or more OFDMA subcarriers. The apparatus is configured as a network coordinator to coordinate asynchronous transmissions for reservation requests of the network nodes.

### BRIEF DESCRIPTION OF THE DRAWINGS

The following will be apparent from elements of the figures, which are provided for illustrative purposes and are not necessarily to scale.

FIG. 1 is an illustration of a known Orthogonal Frequency Division Multiple Access (OFDMA) transmission technique.

FIG. 2 is a block diagram of a communication system.

FIG. 3 is a block diagram of a network node in accordance with the communication system illustrated in FIG. 2.

FIG. 4 is a block diagram of a hardware chip-level implementation of a network node in accordance with the communication system illustrated in FIG. 2.

FIGS. 5A-B are illustrations of OFDMA transmission in accordance with some embodiments.

FIG. 6 is a flow diagram in accordance with some embodiments.

FIG. 7 is a flow diagram in accordance with some embodiments.

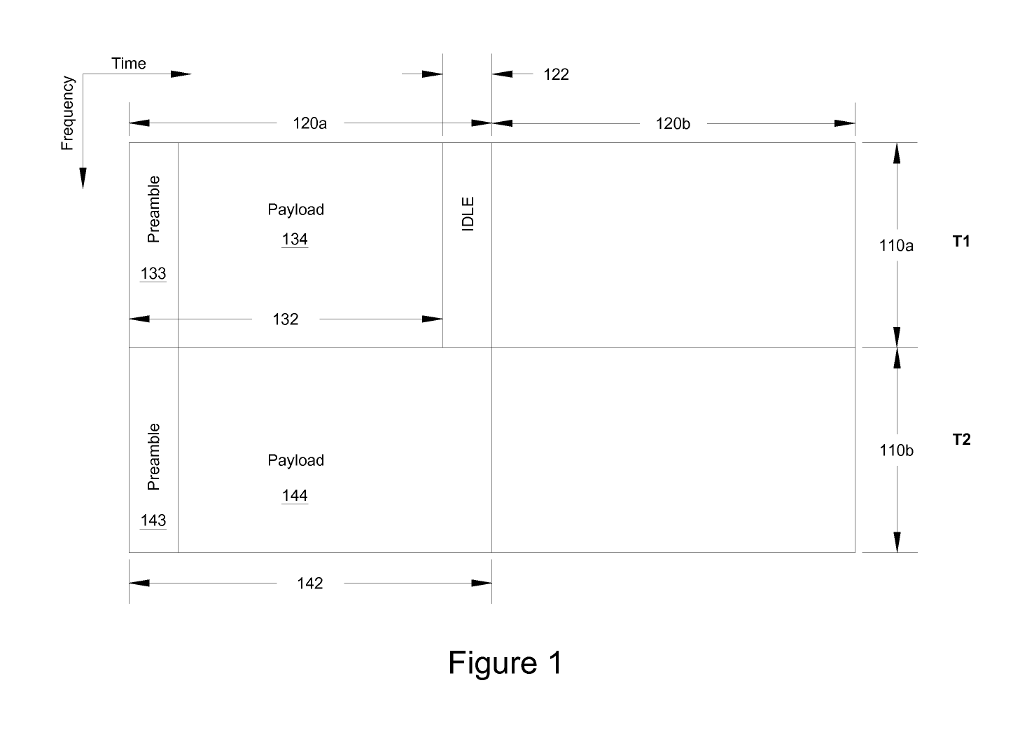

### DETAILED DESCRIPTION

This description of the exemplary embodiments is intended to be read in connection with the accompanying drawings, which are to be considered part of the entire written description.

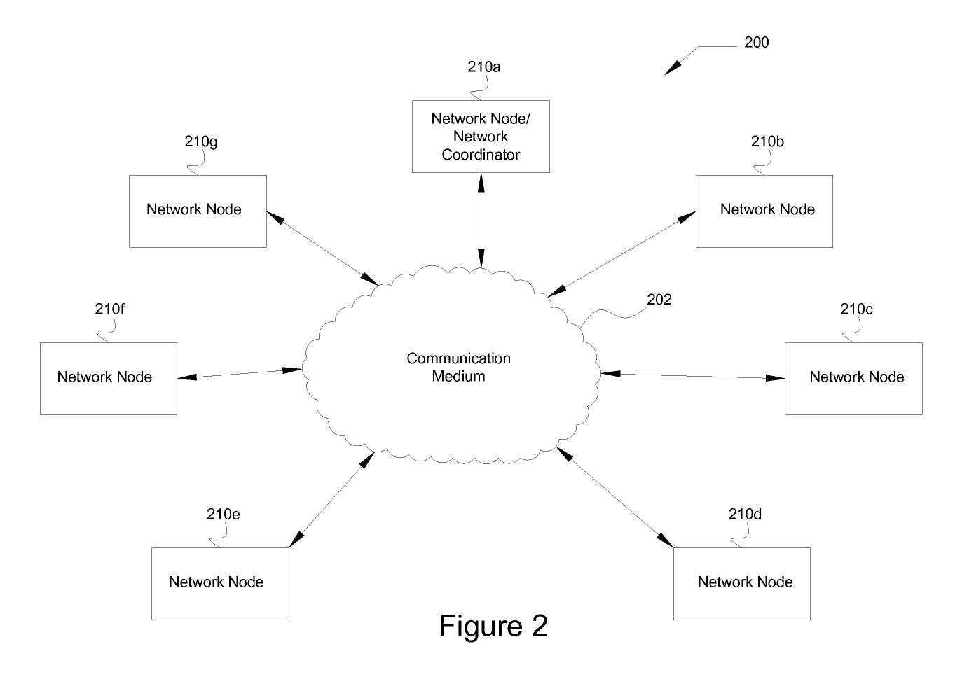

FIG. 2 illustrates one example of a communication system 200 (network 200) including a plurality of network nodes 210a-g (collectively referred to as “network nodes 210”) each configured to communicate with other nodes through a communication medium 202, which may be channel 202. Examples of the communication medium 202 include, but are not limited to, coaxial cable, fiber optic cable, a wireless transmission medium, an Ethernet connection, or the like. It is understood by those known in the art that the term “network medium” is the same as “communication medium.” In one embodiment, communication medium 202 is a coaxial cable network.

Network nodes 210 may be devices of a home entertainment system such as, for example, set top boxes (STBs), television (TVs), computers, DVD or Blu-ray players/recorders, gaming consoles, or the like, coupled to each other via communication medium 202. Various embodiments may be implemented on or using any such network node.

In some embodiments, communication system 200 may be a Multimedia over Coax Alliance (MoCA) network. The MoCA architecture dynamically assigns a network node 210 as a network controller/network coordinator (NC) in order to optimize performance. Any network node 210 may be the NC, as is understood by one of ordinary skill in the art; for the sake of this example, assume network node 210a is an NC. Only a device in the NC 210a role is able to schedule traffic for all other nodes 210b-g in the network and form a full mesh network architecture between any device and its peers.

Embodiments are not limited to MoCA, which is a particular industry standard protocol, but are rather applicable for various access protocols.

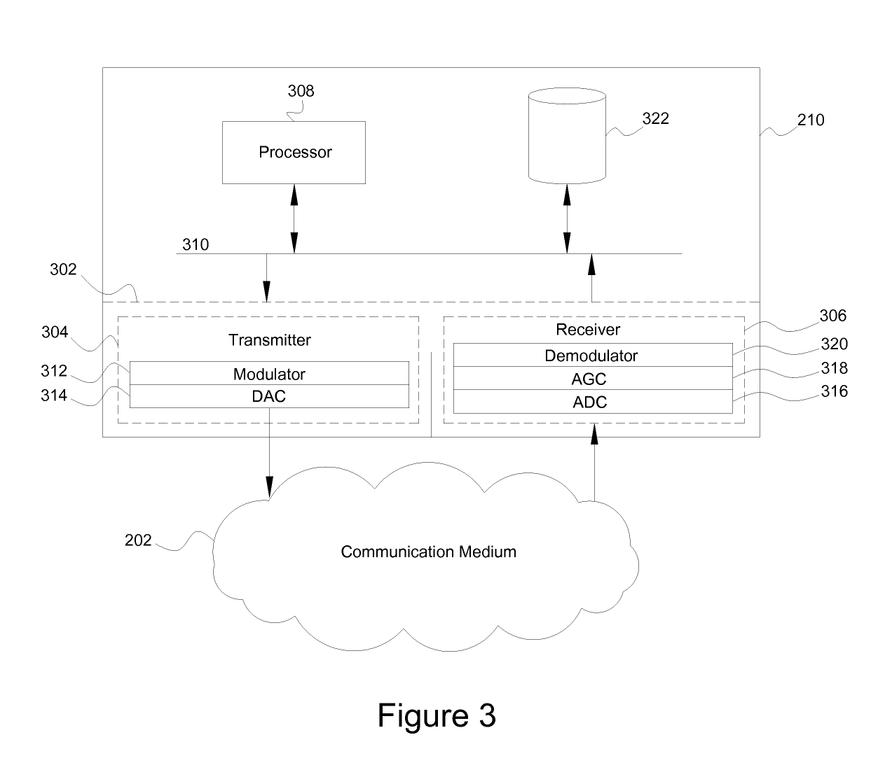

Referring to FIG. 3, each of the network nodes 210 may include a physical interface 302 including a transmitter 304 and a receiver 306, which are in signal communication with a processor 308 through a data bus 310. The transmitter 304 may include a modulator 312 for modulating data according to a quadrature amplitude modulation (QAM) scheme such as, for example, 8-QAM, 16-QAM, 32-QAM, 64-QAM, 128-QAM, or 256-QAM, or another modulation scheme, and a digital-to-analog converter (DAC) 314 for transmitting modulated signals to other network nodes 300 through the communication medium 202.

Receiver 306 may include an analog-to-digital converter (ADC) 316 for converting an analog modulated signal received from another network node 210 into a digital signal. Receiver 306 may also include an automatic gain control (AGC) circuit 318 for adjusting the gain of the receiver 306 to properly receive the incoming signal and a demodulator 320 for demodulating the received signal. One of ordinary skill in the art will understand that the network nodes 210 may include additional circuitry and functional elements not described herein.

Processor 308 may be any central processing unit (CPU), microprocessor, microcontroller, or computational device or circuit for executing instructions. As shown in FIG. 3, the processor 308 is in signal communication with a computer readable storage medium 322 through data bus 310. The computer readable storage medium may include a random access memory (RAM) and/or a more persistent memory such as a read only memory (ROM). Examples of RAM include, but are not limited to, static random-access memory (SRAM), or dynamic random-access memory (DRAM). A ROM may be implemented as a programmable read-only memory (PROM), an erasable programmable read-only memory (EPROM), an electrically erasable programmable read-only memory (EEPROM), or the like as will be understood by one skilled in the art.

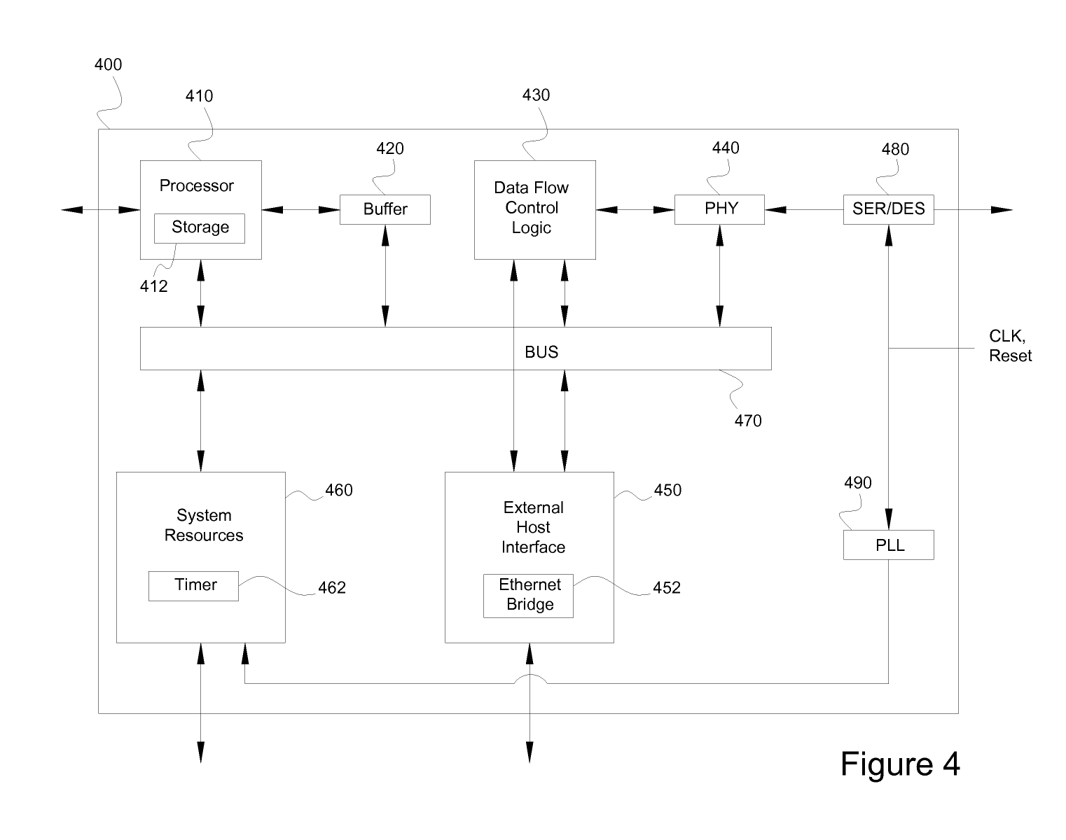

FIG. 4 is a block diagram of a hardware chip-level implementation of a network node in accordance with the communication system illustrated in FIG. 2. FIG. 4 shows various components that may be included on a chip to implement functionality corresponding to a network node. A processor 410 (which may be processor 308 of FIG. 3), a buffer 420, a data flow control logic 430, a physical interface 440, an external host interface, and a system resource module 460 may be configured to communicate via a system bus 470. The processor 420 may include a storage unit 412, which may be computer readable storage medium 322 of FIG. 3. In some embodiments, the storage unit 412 may be separate from the processor 420. The buffer 420, which may be a shared memory, is coupled to the processor 410 and buffers scheduling instructions that may be received from a network coordinator (NC) to facilitate transmission according to a schedule at the node level. The data flow control logic 430 coupled to the physical interface 440 performs low level control functionality. Transmission from the node occurs at the physical layer represented by physical interface 440. The physical interface may be the physical interface 302 of FIG. 3 and may be used for inter-node communications. An optional host interface may include an Ethernet bridge, e.g., for providing compatibility between Ethernet and MoCA. The system resources 460 includes a timer 462 for triggering transmission at scheduled times. A clock signal and a reset signal may be provided to a serializer/deserializer 480, converts between serial and parallel data, and to a phase locked loop 490, which may provide a baseband clock to the system resource module 460.

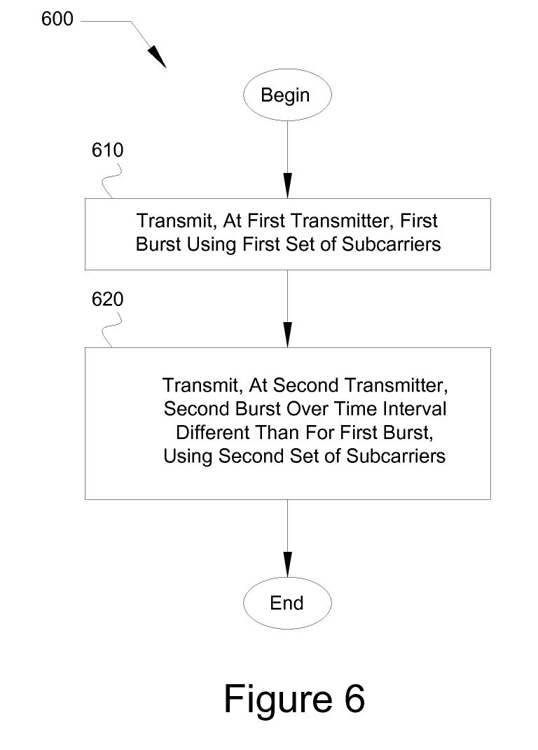

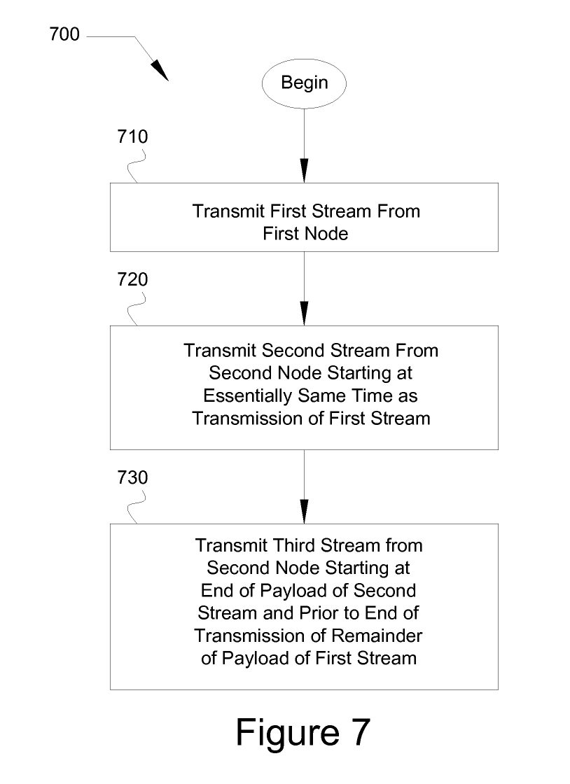

The chip architecture shown in FIG. 4 may be used to implement various embodiments. Other architectures may be used as well. Each network node 210 may be implemented using a separate chip 400. In some embodiments, a node designated as the network coordinator (NC) determines a schedule for allotting frequency slots to various network nodes (each having a transmitter) in a multiple access context with greater flexibility and efficiency than is available in the prior art. The NC distributes pertinent schedule information to respective nodes, e.g., using broadcast messages. Within each chip 400 corresponding to a particular node, the processor 410 functions to implement the transmission schedule for that node. Instructions stored tangibly in storage 412 may cause the processor 410 to effectuate transmission at the physical interface 440 in accordance with processes 600 and 700 described below in the context of FIGS. 6-7. Schedule instructions received from the NC may be stored in buffer 420. Based on the timer 462 and the schedule received from the NC, the processor may cause the transmitter (represented by physical interface 440 in FIG. 4; transmitter details are shown in FIG. 3) to initiate a data burst (data stream).

In accordance within some embodiments, an asynchronous orthogonal frequency division multiple access (OFDMA) scheme is used in which a network coordinator (NC) schedules nodes to start their OFDMA transmissions at the next symbol boundary without waiting for other nodes to finish. This allows, for example, one node to transmit its preamble while another node is transmitting its payload (and vice versa). Since each node is using a different set (subchannel) of subcarriers, the NC can distinguish between them.

Therefore, in accordance with some embodiments, transmitting orthogonal frequency division multiple access signals includes transmitting a first stream of data from a first node of a network. In one such embodiment, the first stream includes a preamble and payload.

A second stream of data is also transmitted from a second node of the network. In one such embodiment, the second stream includes a preamble and payload. However, the second stream has a shorter total length than the first stream. That is, the total amount of time necessary to transmit the preamble and the payload is longer for the second stream than for the first stream. Nonetheless, the transmission of the second stream starts at essentially the same time as the transmission of the first stream.

In addition, in accordance with some embodiments, a third stream of data is transmitted from the second node of the network. The third stream also includes a preamble and payload. The transmission of the third stream begins at the end of the payload of the second stream and prior to the end of the transmission of the remainder of the payload of the first stream.

As in synchronous OFDMA, all subcarrier frequencies are preferably harmonically related to maintain orthogonality at the receiver (NC). Nonetheless, the NC can still perform channel estimation and inverse equalization based on the received preamble symbol(s). The advantages of asynchronous OFDMA are that: (1) it is possible to use relaxed constraints on the scheduler, (2) there may be a simplified assignment and distribution of subchannels, and (3) there will be less waiting (idle time) on the channel. The tradeoff is that the system may be more complex due to the need to receive and process preambles and payloads simultaneously.

In another embodiment, an OFDMA receiver may not require preamble symbols. In this case, payload transmissions from one node may begin at a symbol boundary that is different from the symbol boundary at which other nodes begin their payload transmissions without the added complexity of receiving and processing preambles and payloads simultaneously. Similarly, payload transmissions from one node may end at a symbol boundary that is different from the symbol boundary at which other nodes end their payload transmissions.

Various embodiments may be used in full-mesh OFDMA networks (multipoint-to-multipoint) in which one or more receivers receive transmissions from one or more other transmitters.

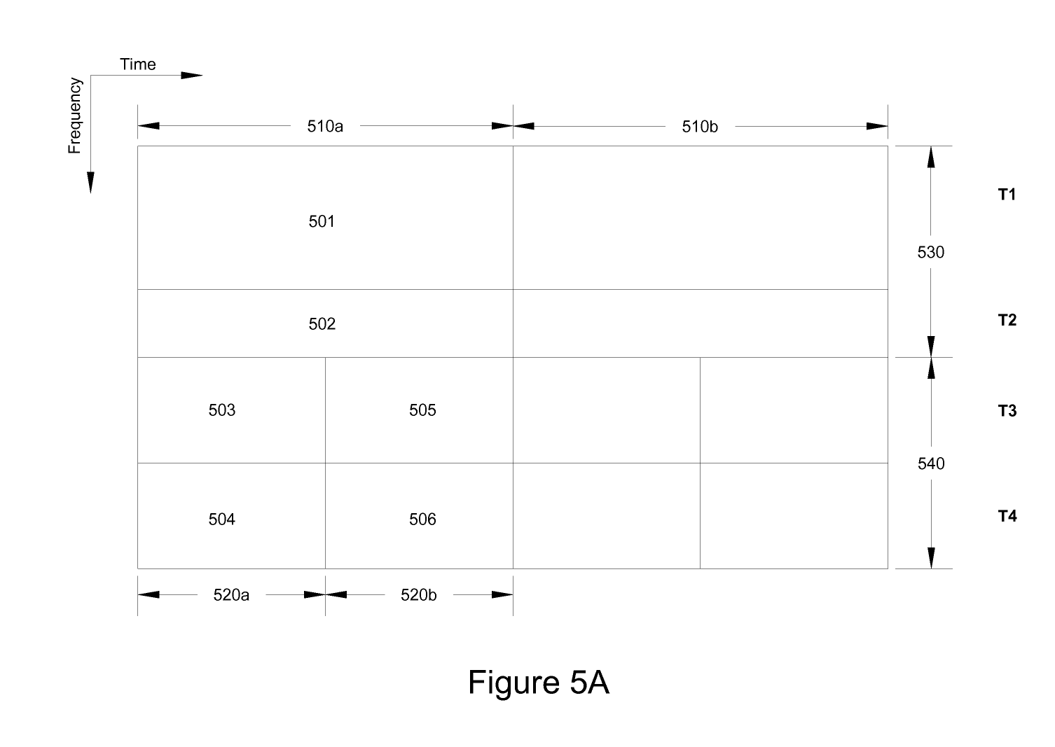

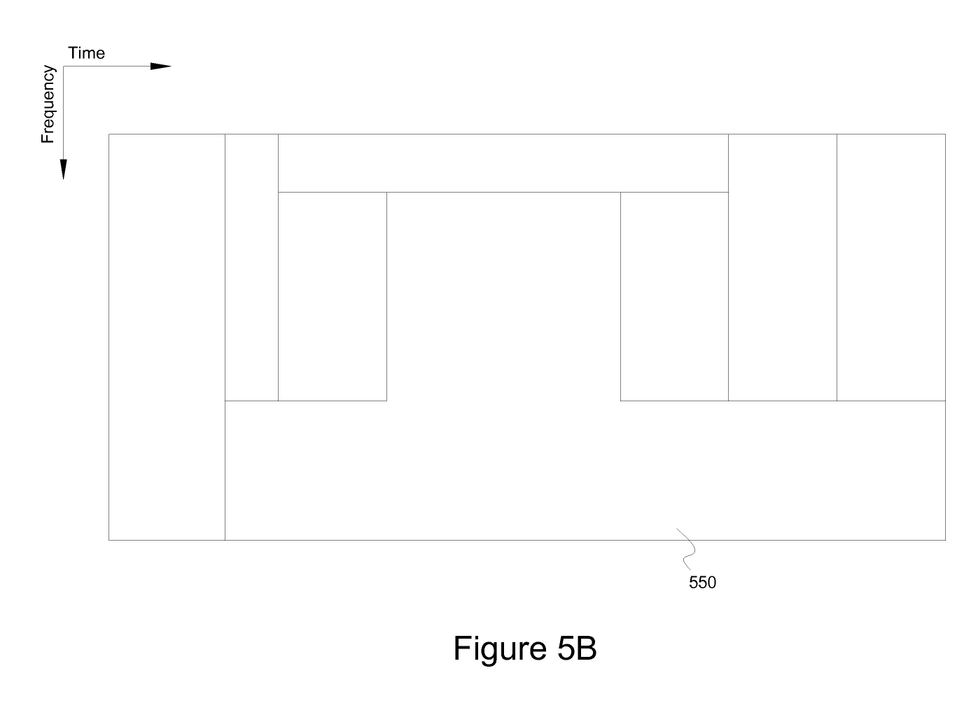

FIGS. 5A-B are illustrations of OFDMA transmission in accordance with some embodiments. FIG. 5A shows allotment of frequency over time for transmitters T1, T2, T3, and T4. The transmitters may be allotted different bandwidths. During time interval 510a, transmitters T1 and T2 are assigned bursts 501 and 502, respectively. Rather than requiring transmitter T3 to adhere to the same timing allotment as transmitters T1 and T2, embodiments allow T3 to transmit bursts 503 and 505 within respective intervals 520a and 520b that are shorter than interval 510a. Similarly, T4 transmits bursts 504 and 506 within intervals 520a and 520b, respectively.

Embodiments provide increased flexibility and efficiency by transmitter T3 to begin a new burst (burst 505) before burst 502 has completed (e.g., before transmission of the entirety of the payload of a packet transmitted in burst 502). Providing a hybrid allotment capability ensures that the best characteristics of both long and short time allotments may be realized in the context of varying service needs. Providing relatively long bursts (e.g., bursts 501 and 502 in FIG. 5A) typically offers the advantage of low overhead at the cost of high latency. Additionally, because a given amount of data transmitted over a longer interval (e.g., with more symbols) requires less bandwidth, increasing the burst time duration typically increases the number of transmitters needed. For the same given amount of data to be transmitted in a multiple access context, reducing burst length reduces latency and the number of transmitters needed but increases overhead (because more bursts need to be scheduled, accounted for, and executed).

To make clear the latency reduction when decreasing burst length, consider the following example. Suppose fixed bursts of length 20 symbols are used, and suppose bursts 501 and 502 are two such 20-symbol bursts. Then the physical layer (PHY) buffering latency (i.e., the time from when a report is received to the next schedulable transmission opportunity, or the time the scheduler must wait for the PHY in other words) is on average half of 20 symbols, i.e., 10 symbols. If the burst length is halved (and the burst frequency width is doubled) to 10 symbols, then PHY buffering latency will be 5 symbols, for an improvement of 5 symbols. In addition to the PHY buffering latency reduction, a PHY transmission duration latency reduction of 10 symbols is observed when reducing the burst length from 20 to 10 symbols. Then, the total PHY latency reduction is 5+10=15 symbols.

Thus, each regime (relatively long or short bursts) has its advantages and disadvantages. Formerly, multiple access implementations have been constrained to one regime or the other. Various embodiments allow the benefits of both regimes to be enjoyed as shown in FIG. 5A. In some embodiments, certain frequency ranges may be reserved for certain traffic classes. For example, frequency interval 530 may be reserved for residential access (e.g., consumer modems), and frequency interval 540 may be reserved for commercial service level agreements (SLAs). Long and short bursts may also be assigned for a given user based on different data characteristics and requirements, e.g., email (tolerant of high latency) and video (demanding low latency). Scheduling OFDMA transmissions asynchronously as in various embodiments, with flexible transmission start times, enables various objectives to be met in changing circumstances.

Asynchronous OFDMA also includes dynamic scheduling and allocation of time-frequency bursts in some embodiments. As shown in FIG. 5B, various types of bursts (having various time durations and frequency extents) may be scheduled and executed, e.g., based on real-time network and traffic conditions. Time-frequency tiles may be configured in various ways and in various shapes. In the example of FIG. 5B, nonrectangular tile 550 may be decomposed into multiple rectangular tiles.

FIG. 6 is a flow diagram in accordance with some embodiments. After process 600 begins, at a first transmitter of a network, a first burst of data having a first symbol length is transmitted (610) over a first time interval using a first set of one or more Orthogonal Frequency Division Multiple Access (OFDMA) subcarriers. At a second transmitter of the network, a second burst of data is transmitted (620) having a second symbol length over a second time interval, different in duration than the first time interval. The second burst of data is transmitted using a second set of one or more OFDMA subcarriers. The first and second sets of subcarriers may be mutually exclusive.

FIG. 7 is a flow diagram in accordance with some embodiments. After process 700 begins, a first stream of data is transmitted (710) from a first node of a network. The first stream includes a preamble and payload. A second stream of data is transmitted (720) from a second node of the network. The second stream includes a preamble and payload, and the second stream has a shorter total length than the first stream. The transmission of the second stream starts at essentially the same time as the transmission of the first stream. A third stream of data is transmitted (730) from the second node of the network. The third stream includes a preamble and payload. The transmission of the third stream begins at the end of the payload of the second stream and prior to the end of the transmission of the remainder of the payload of the first stream.

While various embodiments of the disclosed method and apparatus have been described above, it should be understood that they have been presented by way of example only, and should not limit the claimed invention. The claimed invention is not restricted to the particular example architectures or configurations disclosed. Rather, the desired features can be implemented using a variety of alternative architectures and configurations. Indeed, it will be apparent to one of skill in the art how alternative functional, logical or physical partitioning and configurations can be implemented to implement the desired features of the disclosed method and apparatus. Thus, the breadth and scope of the claimed invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

What is claimed is:

1. A method of transmitting orthogonal frequency division multiple access signals, the method comprising:
transmitting, at a first transmitter of a network, a first burst of data having a first symbol length over a first time interval using a first set of one or more orthogonal frequency division multiple access (OFDMA) subcarriers; and
transmitting, at a second transmitter of the network, a second burst of data having a second symbol length over a second time interval, different in duration than the first time interval, using a second set of one or more OFDMA subcarriers.

2. The method of claim 1 wherein the first and second time intervals overlap one another.

3. The method of claim 1 wherein the first and second time intervals begin at different times.

4. The method of claim 3 wherein the first and second time intervals end at different times.

5. The method of claim 1 wherein the first and second sets of subcarriers are reserved for data of first and second traffic classes, respectively.

6. The method of 5 wherein the first traffic class is residential traffic, and the second traffic class is commercial service level agreement (SLA) traffic.

7. The method of claim 1, further comprising:
assigning a first codeword to the first burst at a first group of subcarriers and a first symbol slot; and
assigning a second codeword to the first burst at the first group of subcarriers and a second symbol slot succeeding the first symbol slot in time.

8. The method of claim 1, further comprising:
assigning a first codeword to the first burst at a first subcarrier and a first group of symbol slots; and
assigning a second codeword to the first burst at the first group of symbol slots and a second subcarrier succeeding the first subcarrier in frequency.

9. The method of claim 1, further comprising:
assigning a first codeword to the first burst at a first group of subcarriers and a first symbol slot;
assigning a second codeword to the first burst at the first group of subcarriers and a second symbol slot succeeding the first symbol slot in time;
assigning a third codeword to the second burst at a first subcarrier and a first group of symbol slots; and
assigning a second codeword to the second burst at the first group of symbol slots and a second subcarrier succeeding the first subcarrier in frequency.

10. A method of transmitting orthogonal frequency division multiple access signals, the method comprising:
a) transmitting a first stream of data from a first node of a network, the stream including a preamble and payload;
b) transmitting a second stream of data from a second node of the network, the second stream including a preamble and payload, the second stream having a shorter total length than the first stream, the transmission of the second stream starting at essentially the same time as the transmission of the first stream; and
c) transmitting a third stream of data from the second node of the network, the third stream including a preamble and payload, the transmission of the third stream beginning at the end of the payload of the second stream and prior to the end of the transmission of the remainder of the payload of the first stream.

11. An apparatus forming a network node on a network, said apparatus comprising:
a computer processor;
a physical layer interface including a transmitter and a receiver, said physical layer interface configured to provide communication between said apparatus and at least one other network node on the network, said at least one other network node including a network coordinator (NC);
a buffer coupled to said processor, said buffer configured to store schedule orders received from said NC;
a timer;
a bus configured to provide communication between said processor, said physical layer interface, said buffer, and said timer;
a computer readable storage medium having computer-executable instructions stored tangibly thereon, said instructions when executed causing said processor to transmit, at a time based on the stored schedule orders and the timer, a first burst of data having a first symbol length over a first time interval using a first set of one or more orthogonal frequency division multiple access (OFDMA) subcarriers;
wherein the first burst of data has a different symbol length than a second burst of data that is transmitted at one of the other network nodes over a second time interval different in duration than the first time interval.

12. An apparatus forming a network node on a network, said apparatus comprising:
a computer processor;
a physical layer interface including a transmitter and a receiver, said physical layer interface configured to provide communication between said apparatus, a first recipient network node on the network, and a second recipient network node on the network;
a bus configured to provide communication between said processor and said physical layer interface;
a computer readable storage medium having computer-executable instructions stored tangibly thereon, said instructions when executed causing said processor to:
transmit a first plurality of schedule orders to the first recipient network node, the first schedule orders instructing the first recipient node to transmit a first burst of data having a first symbol length over a first time interval using a first set of one or more orthogonal frequency division multiple access (OFDMA) subcarriers;
transmit a second plurality of schedule orders to the second recipient network node, the second schedule orders instructing the second recipient node to transmit a second burst of data having a second symbol length over a second time interval, different in duration than the first time interval, using a second set of one or more OFDMA subcarriers;
wherein said apparatus is configured as a network coordinator to coordinate asynchronous transmissions for reservation requests of the network nodes.
